(19) United States
(12) Patent Application Publication
(10) Pub. No.: US 2004/0030610 A1
(43) Pub. Date: Feb. 12, 2004

(54) Parts ordering system, parts ordering apparatus, parts ordering method, and storage medium

(76) Inventor: Kaori Mimura, Tokyo (JP)

Correspondence Address: MORRISON & FOERSTER LLP, 1650 TYSONS BOULEVARD, SUITE 300, MCLEAN, VA, 22102, US

(21) Appl. No.: 10/410,604

(22) Filed: Apr. 10, 2003

(30) Foreign Application Priority Data
Apr. 12, 2002 (JP) 2002-110737

(51) Int. Cl. G06F 17/60

(52) U.S. Cl. 705/26

(57) ABSTRACT

When a user gains access to a parts management server from a user terminal, the parts management server specifies the user, who has accessed, and electronic equipment that is used by the relevant user, thereafter sending image information for designating a fault location to the terminal to display. The parts management server receives the fault location of the designated electronic equipment from the user terminal based on the image information, and determines whether user repair of the fault location of the electronic equipment is possible. When determining the user repair is possible, the parts management server causes the user terminal of the electronic equipment to display parts information of the part corresponding to the fault location of the electronic equipment and to order a replacement part corresponding to the fault location. This makes it possible for the user to order the replacement part of the broken-down equipment if the user can repair the fault by himself/herself.

### BACKGROUND OF THE INVENTION

1. Field of the Invention

The present invention relates to a parts ordering system, which is connected to an information input/output device via a communication network to receive an order for parts of electronic equipment, a parts ordering apparatus, a parts ordering method, and a storage medium.

2. Description of the Related Art

In conventional, when electronic equipment such as a printer apparatus, a facsimile apparatus, a copy machine, an MFP (Multi Function Peripheral) and the like breaks down and needs replacement parts relevant to the fault locations, the need for replacement parts is displayed on a control panel of the relevant electronic equipment to request a user to replace the parts in many cases.

However, when the need for replacement parts is displayed on the control panel of the electronic equipment, the user can not easily determine in general cases whether the user can replace the parts by himself/herself or must ask a service person or a service center to which the service person belongs for repairs.

Moreover, even when the user can determine that he/she can replace the parts and repair the electronic equipment by himself/herself, ordering work of replacement parts necessary for repairs is often complicated. Furthermore, at the service center to which the service persons belong, they must receive the order of the replacement parts from the user through a telephone and the like in spite of the fact that the user can replace the parts and repair the electronic equipment by himself/herself. This causes a problem that unnecessary time and labor are taken.

The present invention has been made with consideration given to the aforementioned circumstances, and an object of the present invention is to provide a parts ordering system, which reduces time and labor required for repair of electronic equipment, a parts ordering apparatus, a parts ordering method, and a storage medium.

### SUMMARY OF THE INVENTION

In order to attain the above object, a parts ordering system according to a first aspect of the present invention is a parts order management system includes terminals and parts ordering apparatuses that are connected to the terminals via a predetermined network to receive a parts order from the terminal. The parts ordering apparatuses store storing user information, repair person information, fault location specifying information for specifying a fault location of predetermined electronic equipment, and parts information on a part corresponding to the fault location of the electronic equipment. The parts ordering apparatuses specify electronic equipment that is used by a user, who has accessed from the terminal, based on the user information. The parts ordering apparatuses send the fault location specifying information on the specified electronic equipment to display, and receiving designation of the fault location from the terminal based on the fault location specifying information. The parts ordering apparatuses determine whether user repair of the designated fault location of the electronic equipment is possible. The parts ordering apparatuses cause the terminal to display the parts information of a replacement part for repairing the fault location of the electronic equipment when it is determined that user repair of electronic equipment is possible and receiving an order of the replacement part from the terminal based on the parts information. The parts ordering apparatuses report to a service center, which receives repair of electronic equipment, that the relevant electronic equipment breaks down when it is determined that user repair of the electronic equipment is impossible.

Further, the parts ordering apparatus may specify a repair person, who has accessed from the terminal, based on the repair person information. The parts ordering apparatuses may send the fault location specifying information for specifying a fault location of predetermined electronic equipment to the terminal that is used by the repair person to display, and receive designation of the fault location from the terminal based on the fault location specifying information. The parts ordering apparatuses may cause the terminal to display repair information corresponding to the fault location of the electronic equipment, and receive an order of a replacement part corresponding to the fault location from the terminal based on the repair information.

The fault location specifying information may be image information of electronic equipment, and the parts ordering apparatuses cause the terminal to display the fault location based on a display screen on which the image information is displayed by the terminal.

In order to attain the above object, the parts ordering apparatus according to a second aspect of the present invention is a parts ordering apparatus that is connected to terminals via a predetermined communication network to receive a parts order from the terminals. The parts ordering apparatus includes user specifying means for specifying a user, who has accessed from the terminal, and electronic equipment that is used by the relevant user. The parts ordering apparatus includes first fault location designating means for sending fault location specifying information for specifying a fault location of the electronic equipment to the terminal to display and for designating the fault location of the electronic equipment from the terminal based on the fault location specifying information. The parts ordering apparatus includes first fault location receiving means for receiving the fault location of the electronic equipment designated by the first fault location designating means from the terminal. The parts ordering apparatus includes user repair possibility determining means for determining whether user repair of the received fault location of the electronic equipment is possible. The parts ordering apparatus includes first replacement part displaying and ordering means for causing the terminal to display information corresponding to the relevant fault location of the electronic equipment and to order a replacement part corresponding to the fault location of the electronic equipment from the terminal based on the information when user repair possibility determining means determines that user repair of the received fault location of the electronic equipment is possible. The parts ordering apparatus includes first replacement part ordering means for receiving an order of the replacement part by the first replacement part displaying and ordering means.

Since this makes it possible for the user of electronic equipment to easily determine whether the user can repair the fault location by himself/herself when the electronic equipment breaks down, the user can order only the replacement part immediately if he/she can repair the fault by himself/herself. Accordingly, this eliminates the user having to pay the unnecessary repair cost and make a service call.

In the aforementioned structure, the parts ordering apparatus may further include fault reporting means for reporting to a service center, which receives repair of predetermined electronic equipment, that the relevant electronic equipment breaks down when user repair possibility determining means determines that user repair of the received fault location of the electronic equipment is impossible.

Accordingly, it is possible for the user to make a service call immediately when the user cannot repair the equipment by himself/herself.

In the aforementioned structure, the parts ordering apparatus may further include repair person specifying means for specifying a repair person, who has accessed from the terminal, and electronic equipment to be repaired by the relevant repair person. The parts ordering apparatus may further include second fault location designating means for sending fault location specifying information for specifying a fault location of the electronic equipment to the terminal to display and for designating the fault location of the electronic equipment from the terminal based on the fault location specifying information. The parts ordering apparatus may further include second fault location receiving means for receiving the fault location of the electronic equipment designated by the second fault location designating means from the terminal. The parts ordering apparatus may further include second replacement part displaying and ordering means for causing the terminal to display information corresponding to the fault location of the electronic equipment received by the second fault location receiving means and to order a replacement part corresponding to the fault location of the electronic equipment from the terminal based on the information. The parts ordering apparatus may further include second replacement part ordering means for receiving an order of the replacement part by the second replacement part displaying and ordering means.

This makes it possible for the repair person to order the replacement part immediately from the destination to which he/she makes a visit.

In the aforementioned structure, replacement parts information corresponding to the fault location may be included in information corresponding to the fault location of the electronic equipment displayed on the terminal by the first replacement part displaying and ordering means.

Accordingly, the user can recognize information relating to the replacement part such as price of replacement part, stock quantity, replacement method, etc.

In the aforementioned structure, replacement parts information corresponding to the fault location may be included in information corresponding to the fault location of the electronic equipment displayed on the terminal by the second replacement part displaying and ordering means.

Accordingly, since the repair person can recognize information relating to the replacement part such as a price of replacement part, stock quantity, replacement method, whether regular replacement part or not, replacement time and the like, the repair person does not have to carry a parts catalogue, and the like.

In the aforementioned structure, the parts ordering apparatus may further include repair part storing means for storing information relating to the user, information relating to the electronic equipment and information relating to the fault location of the electronic equipment to be associated with one another when the fault location of the electronic equipment is received by the first fault location receiving means.

Since the frequency of parts replacement of electronic equipment is recognized, it is possible for the supplier of electronic equipment to make these information items useful for a future development.

It is possible to a program, which causes a computer to execute all or a part of the functions of the respective means, by being recorded on a computer-readable storage medium, or by being transferred by a computer-operable carrier wave.

In order to attain the above object, a parts ordering method according to a third aspect of the present invention is a parts ordering method in which connection to terminals is made via a predetermined network to receive a parts order from the terminal, the method includes the step of storing user information, repair person information, fault location specifying information for specifying a fault location of predetermined electronic equipment, and parts information on a part corresponding to the fault location of the electronic equipment. The method includes the step of specifying a user, who has accessed from the terminal and electronic equipment that is used by the relevant user, based on the user information. The method includes the step of sending the fault location specifying information on the specified electronic equipment to display. The method includes the step of receiving designation of the fault location from the terminal based on the fault location specifying information to determine whether user repair of the designated fault location of the electronic equipment is possible. The method includes the step of causing the terminal to display the parts information corresponding to the fault location of the electronic equipment when it is determined that user repair of electronic equipment is possible. The method includes the step of receiving an order of the replacement part corresponding to the fault location from the terminal based on the parts information.

In the above method, the parts ordering method may further include the step of reporting to a service center, which receives repair of the electronic equipment, that the relevant electronic equipment breaks down when it is determined that user repair of the electronic equipment is impossible in the determining step.

In the above method, the parts ordering method may further include the step of specifying a repair person, who has accessed from the terminal, based on the repair person information. The method may further include the step of sending the fault location specifying information for specifying a fault location of predetermined electronic equipment to the terminal that is used by the repair person to display. The method may further include the step of receiving designation of the fault location from the terminal based on the fault location specifying information to cause the terminal to display repair information corresponding to the fault location of the electronic equipment. The method may further include the step of receiving an order of a replacement part corresponding to the fault location from the terminal based on the repair information.

In the above method, the parts ordering method may further include the step of storing information relating to the user, information relating to the electronic equipment and information relating to the fault location of the electronic equipment to be associated with one another when the fault location of the electronic equipment is received based on the fault location specifying information in the determining step.

### BRIEF DESCRIPTION OF THE DRAWINGS

These objects and other objects and advantages of the present invention will become more apparent upon reading of the following detailed description and the accompanying drawings in which:

FIG. 1 is a system configuration view showing an entire configuration of a parts ordering system according to one embodiment of the present invention;

FIG. 2 is a block diagram showing an electrical connection of the respective components of a parts management server;

FIG. 3 is a schematic view showing a data structure of electronic equipment image data stored in an electronic equipment image file;

FIG. 4 is a schematic view showing a data structure of user data stored in a user data file;

FIG. 5 is a schematic view showing a data structure of user-oriented parts information data stored in a user-oriented parts information data file;

FIG. 6 is a schematic view showing a data structure of service person-oriented parts information data stored in a service person-oriented parts information data file;

FIG. 7 is a schematic view showing a data structure of service person data stored in a service person data file;

FIG. 8 is a block diagram showing an electrical connection of the respective components of a user terminal;

FIG. 9 is a flowchart showing a screen image displayed on a display section of the user terminal at the time of browsing a WEB page of the parts management server from the user terminal via the Internet;

FIG. 10 is a flowchart showing a process flow using a CGI program (CGI 1);

FIG. 11 is a flowchart showing a process flow using a CGI program (CGI 2);

FIG. 12 is a flowchart showing a process flow using a CGI program (CGI 3);

FIG. 13 is a flowchart showing a process flow using a CGI program (CGI 4);

FIG. 14 is a flowchart showing a screen image displayed on a display section of a portable terminal at the time of browsing the WEB page of the parts management server from the user terminal via the Internet;

FIG. 15 is a flowchart showing a process flow using a CGI program (CGI 5);

FIG. 16 is a flowchart showing a process flow using a CGI program (CGI 6);

FIG. 17 is a flowchart showing a process flow using a CGI program (CGI 7); and

FIG. 18 is a schematic diagram showing another example of a fault location designation page displayed on a display section of a user terminal at the time of browsing a WEB page of a parts management server from the user terminal.

### DETAILED DESCRIPTION OF THE PREFERRED EMBODIMENT

A parts ordering apparatus of this embodiment is applied to a parts ordering system that aims to order replacement parts relevant to fault locations when electronic equipment such as an MFP (Multi Function Peripheral) breaks down.

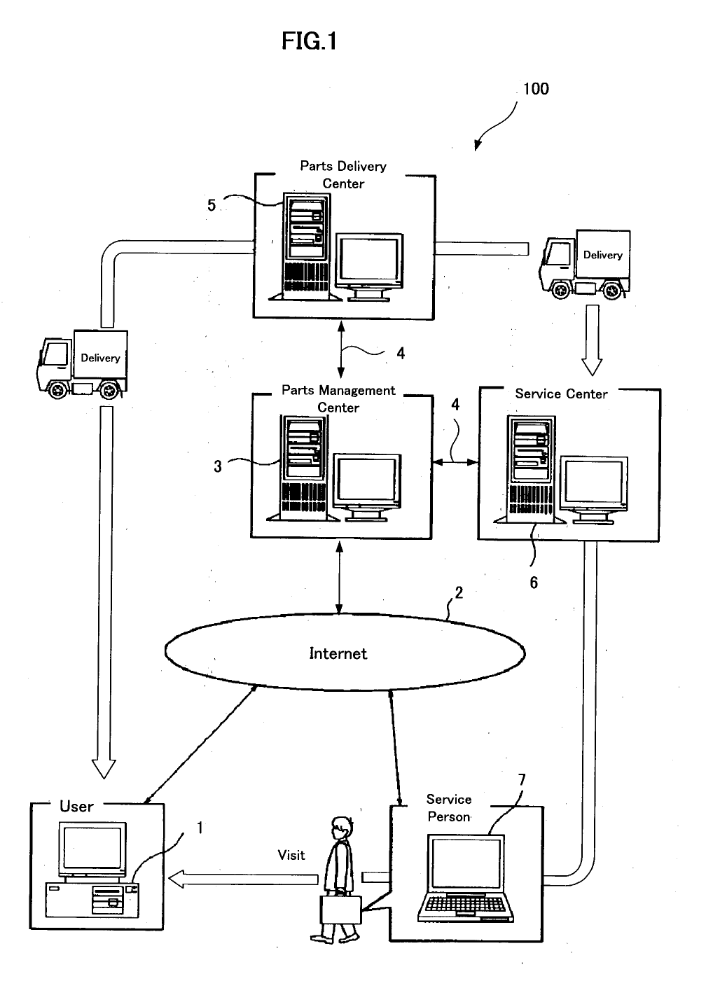

Here, FIG. 1 is a system configuration view schematically showing an entire configuration of a parts ordering system 100. As illustrated in FIG. 1, the parts ordering system 100 includes a user terminal 1, a parts management server 3, delivery management server 5, a repair management server 6, and a portable terminal 7. It is assumed that the parts ordering apparatus according to this embodiment includes the parts management server 3, delivery management server 5 and repair management server 6.

The parts management server 3 is connected to the delivery management server 5 and repair management server 6 via a LAN (Local Area Network) 4. The user terminal 1 and portable terminal 7 are connected or connectable to the parts management server 3.

The user terminal 1 is a PC (Personal Computer) that is installed at a user side where electronic equipment such as MFP and the like is used. The parts management server 3 is a server computer that is provided at a parts management center of an electronic equipment manufacturer. The delivery management server 4 is a server computer that is provided at the parts delivery center of the electronic equipment manufacturer. The delivery management server 5 is a server computer that is provided at the service center of the electronic equipment manufacturer.

As illustrated in FIG. 1, parts are delivered by a home delivery service and the like between the parts delivery center and the user and between the parts delivery center and the service center.

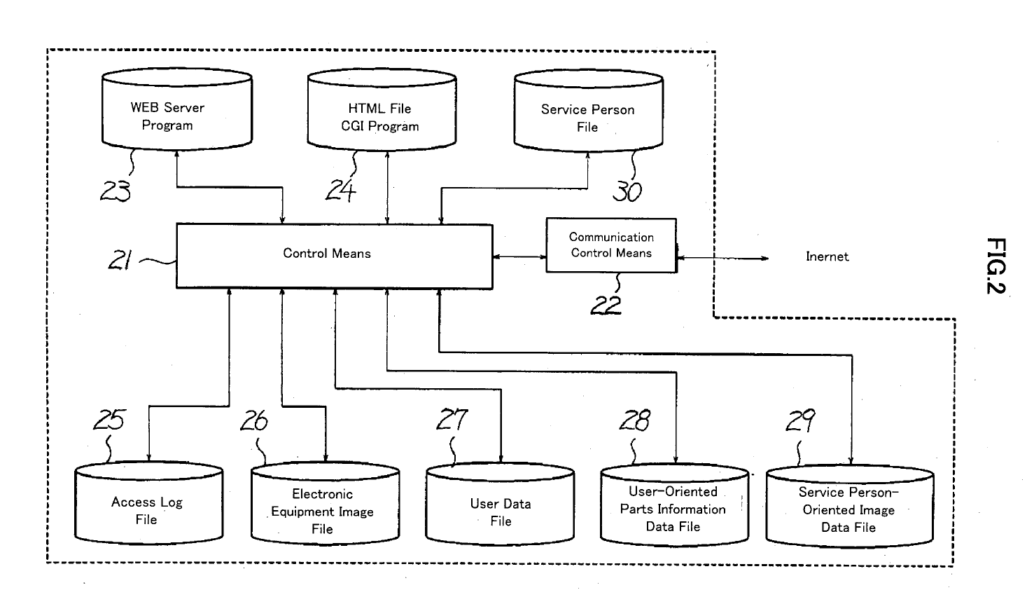

First, a specific explanation is given of the parts management server 3. FIG. 2 is a block diagram showing an electrical connection of the respective components of the parts management server 3. As illustrated in FIG. 2, in the parts management server 3, there is provided control means 21 including a CPU (Central Processing Unit), which controls the respective components concentratedly, a ROM (Read Only Memory) that stores a control program, a RAM (Random Access Memory) that functions as a work area of CPU, and the like. Then, communication control means 22 and storage devices 23 to 30 are connected to the control means 21. The control means 21 controls these components to execute a data transfer, a program, and various operations.

The communication control means 22 includes a predetermined interface (I/F), and controls data input/output to/from the user terminal 1, portable terminal 7, delivery management server 5, repair management server 6 via the Internet and LAN 4.

The storage device 23 and 24 are internal storage devices each including a HDD (Hard Disk Drive) or external storage devices. The storage device 23 stores a WEB server program. The storage device 24 stores an HTML (Hyper Text Markup Language) file and an external program (hereinafter referred to as CGI program) called via a CGI (Common Gateway Interface).

Here, the WEB server program is a program that sends browsing information to the user terminal 1 and portable terminal 7 by executing the transfer of the HTML file and CGI program when a browse request for WEB is issued from the user terminal 1, which is installed at the user side, and the portable terminal 7, which is possessed by a service person (repair person) belonging to the service center, via the Internet 2.

The storage device 25 is a storage device (hereinafter referred to as access log file) that stores access log data on electronic equipment fault information. The storage device 26 is a storage device (hereinafter referred to as electronic equipment image file) that stores image data of electronic equipment as fault location specific information for specifying a fault location of electronic equipment. The storage device 27 is a storage device (hereinafter referred to as user data file) that stores user data of various kinds for each user. The storage device 28 is a storage device (hereinafter referred to as user-oriented parts information data file) that stores parts information data for user repair. The storage device 29 is a storage device (hereinafter referred to as service person-oriented parts information data file) that stores parts information data for service person repair. The storage device 30 is a storage device (hereinafter referred to as service person data file) that stores service person data of various kinds for each service person.

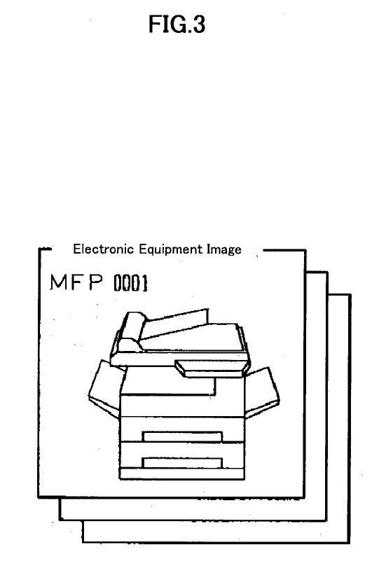

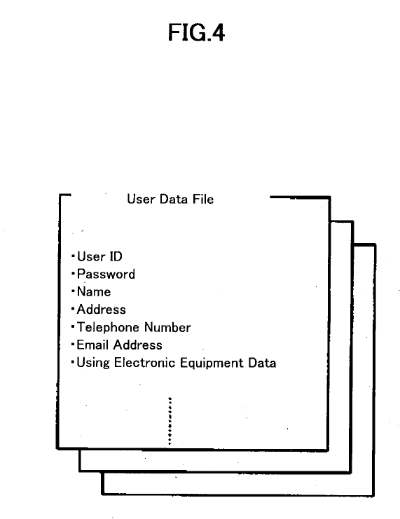

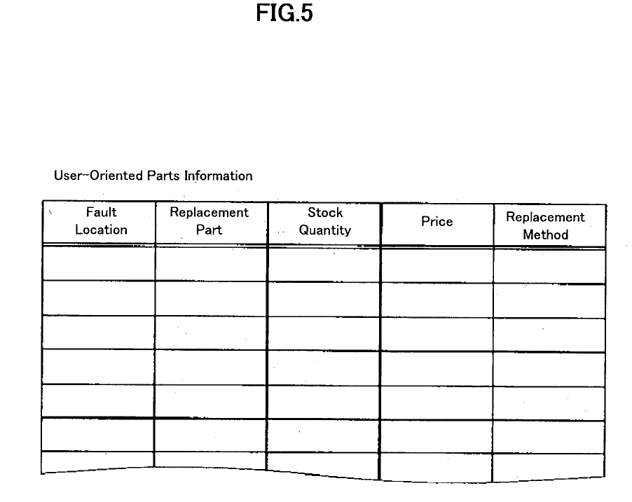

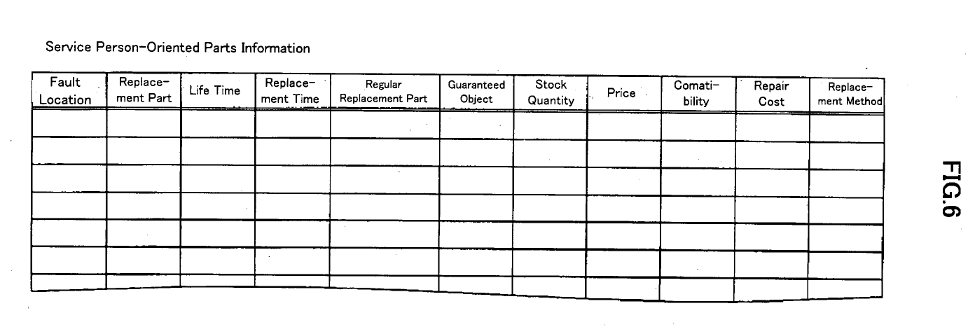

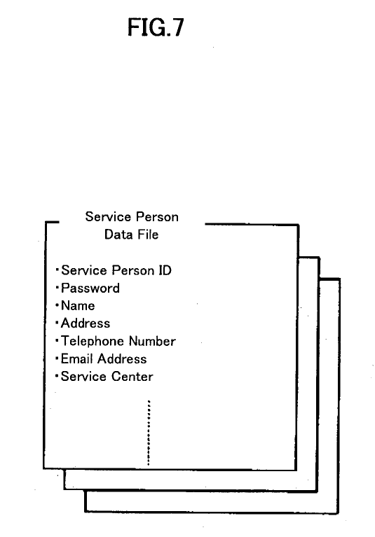

The access log file 25 stores date and time information, user information, a kind of broken-down electronic equipment, a fault location of the electronic equipment and the like at the time of receiving a notification of a fault location from the user terminal 1. The electronic equipment image file 26 stores image data on the electronic equipment to be associated with a name of electronic equipment and an identification number indicating electronic equipment as shown in FIG. 3. The user data file 27 stores data on a user ID, password, name, address, telephone number, E-mail address and using electronic equipment data that the relevant user uses as shown in FIG. 4. The user-oriented parts information data file 28 stores information on a part necessary for replacement corresponding to the fault location of electronic equipment and accompanying information, including a stock quantity, a price and a replacement method, accompanied by the replacement part as shown in FIG. 5. The service person-oriented parts information data file 29 stores data on a part necessary for replacement according to a fault location of electronic equipment, life time of part, replacement time, whether regular replacement part or not, whether guaranteed object or not, a stock quantity, a price, compatibility, a repair cost, and a replacement method as accompanying information that is accompanied by the replacement part as shown in FIG. 6. The service person data file 30 stores data on a service person ID, password, name, telephone number, Email address, and the service center to which the relevant service person belongs as shown in FIG. 7.

The delivery management server 5 and repair management server 6 have the configuration, which is analogous to the parts management server 3. However, the contents of the files stored in the storage device connected to the control means are different from the parts management server 3. Particularly, in the shipping management sever 5 and repair management server 6, programs stored in the storage devices corresponding to the storage devices 23 and 24 of the parts management server 3 are different from the program of the parts management server 3. Each of the delivery management server 5 and repair management server 6 exerts a function unique to each server by the program stored in the storage device.

The delivery management server 5 receives predetermined order information sent from the parts management server 3, which has received an order of part from the user or service person, and generates delivery information for delivering the ordered part to a predetermined delivery location based on the relevant order information. Moreover, the repair management server 6 receives predetermined fault notice information sent from the parts management server 3, which has received service call information on the fault location from the user, and generates service management information for deciding a service person, who is in charge of repair work, and time and date for visit based on the relevant fault notice information.

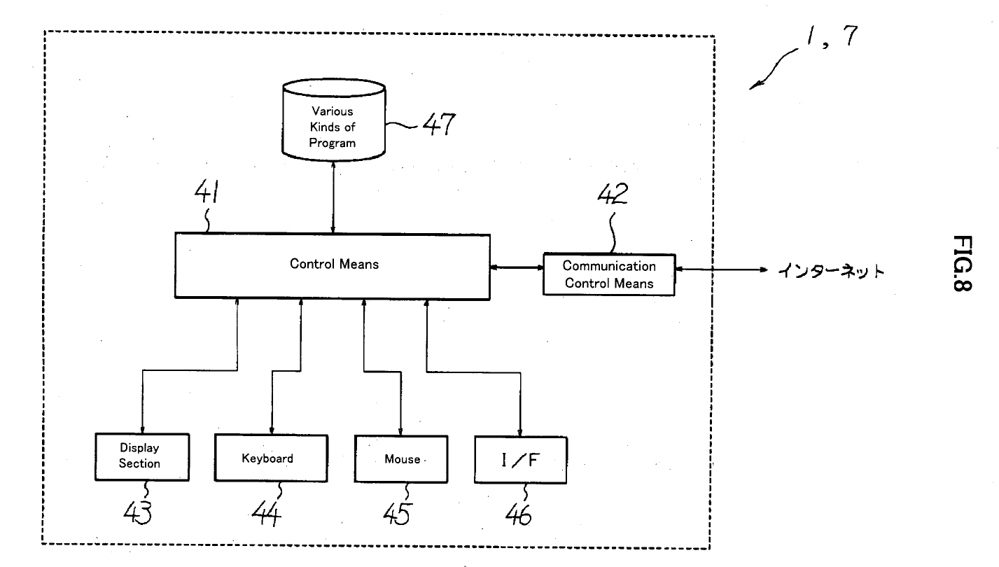

A brief explanation is next given of the user terminal 1, which is installed at each user side, and the portable terminal 7, which is possessed by the service person belonging to the service center. FIG. 8 is a block diagram showing an electrical connection of the respective components of the terminals 1 and 7. As illustrated in FIG. 8, in each of the terminals 1 and 7, there is provided control means 41 including a CPU, which controls the respective components concentratedly, a ROM that stores a control program, a RAM that functions as a work area of CPU, and the like. Then, communication control means 42 and storage device 47 are connected to the control means 41. The control means 41 controls data input/output to/from the parts management server 3 via the Internet 2. The storage device 47 is storage device such as an HDD and the like, and stores various kinds of programs such as a program that implements a browsing function via the Internet 2. In addition, the programs stored in the storage device 47 by the respective terminals 1 and 7 are different. By the difference in the program, the terminals 1 and 7 can function as user terminal and service person terminal, respectively.

Each of the terminals 1 and 7 has a display section 43, a key board 44, a mouse 45, and an interface (I/F) 46, and is controlled by control means 41. The display section 43 is a display device including a CRT (Cathode Ray Tube), an LCD (Liquid Crystal Display) and the like. The key board 44 functions as an input section for inputting various data. The mouse 45 functions as a pointing device, and may be a track ball and like. The interface 46 controls data reception/transmission between various kinds of external devices.

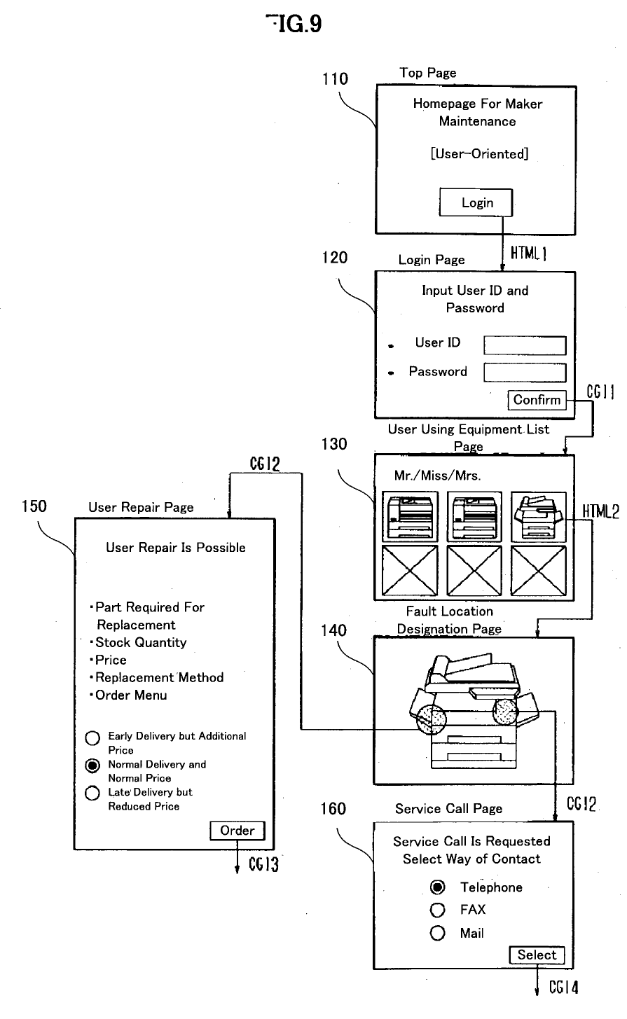

An explanation is next given of the operation of each component of the parts ordering system 100 for each processing described below. FIG. 9 is a flowchart showing a screen image displayed on the display section 43 of the user terminal 1 at the time of browsing a WEB page of the parts management server 3 from the user terminal 1 via the Internet. Additionally, in FIG. 9, “HTML+‘number’” indicates that control means 21 of the parts management server 3 executes processing, which displays an HTML file prestored in the storage device 24, based on a WEB server program of the storage device 23. Moreover, “CGI+‘number’” indicates that control means 21 of the parts management server 3 executes a CGI program stored in the storage device 24. More specifically, control means 21 changes browsing information in accordance with the request from a viewer and executes processing of various files.

[Login]

In order to receive the service provided by the parts ordering system 100 when the electronic equipment breaks down, the user must gain access to a predetermined URL (Uniform Resource Locator) provided by the parts management server 3 and login to a WEB site of the parts management center. As shown in FIG. 9, when a “login button” on a screen 110 (top page of the WEB site) displayed on the display section 43 of the user terminal 1 is clicked by the mouse 45, the control means 21 of the parts management server 3 displays a next screen 120 in response to the relevant operation (HTML 1).

The screen 120 is a login page. Since a form for inputting a user ID and a password is displayed on the screen 120, the user inputs each item by the keyboard 44. Then, when the user clicks a “confirmation button” of the login page by the mouse 45 after inputting the necessary items, the control means 21 starts to execute a CGI program (CGI 1) in response to this operation.

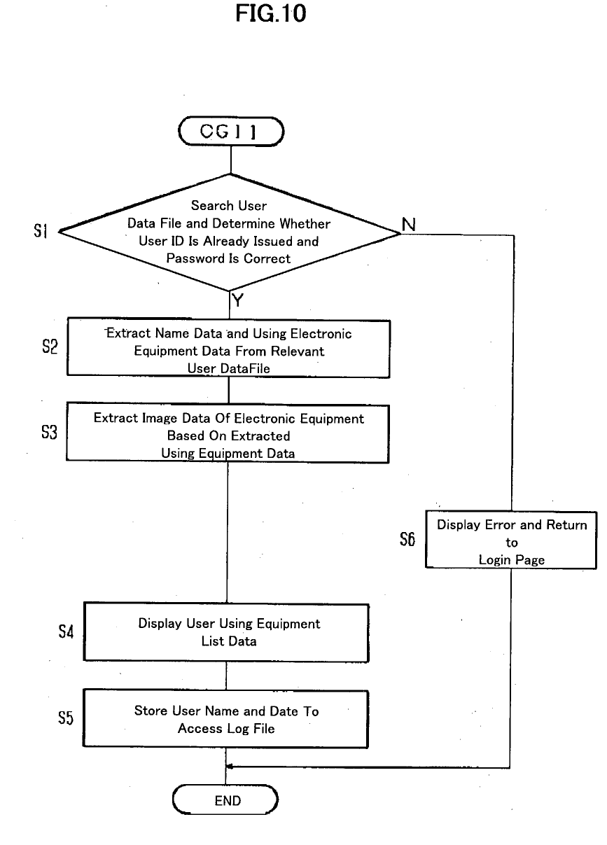

FIG. 10 is a flowchart showing a process flow using a CGI program (CGI 1). As shown in FIG. 10, the control means 21 determines whether the input user ID and password are correct with reference to the user data file 27 according to the CGI program (CGI 1) (step S1). More specifically, the control means 21 determines whether the input user ID and password are correct by making comparison between the user ID and password stored in the user data file 27 and the input user ID and password.

When determining that the input user ID and password are correct (YES in step S1), the control means 21 extracts a logged-in user name and using electronic equipment data from the user data file 27 (step S2).

Moreover, the control means 21 searches the electronic equipment image file 26 based on using electronic equipment data extracted in step S2 to extract image data of the relevant electronic equipment (step S3). More specifically, the control means 21 compares an identification number, which represents electronic equipment stored in the electronic equipment image file 26, with an identification number, which represents electronic equipment included in the using electronic equipment data extracted in step S2, thereby extracting image data of at least one or more electronic equipment.

When the user name and the image data of the using electronic equipment are extracted, the control means 21 causes the display section 43 of the user terminal 1 to display a user using equipment list page (step S4). A screen 120 of FIG. 9 is a user using equipment list page. As illustrated in FIG. 9, on the screen 130, the user name extracted in step S2-is displayed at the top, and image data of the electronic equipment used the relevant user extracted in step S3 is displayed by a thumb nail (reduced image for preview).

Moreover, the control means 21 causes the access log file 25 to store the user name extracted in step S2 together with date.

In addition, when determining that at least one of the user ID and password is incorrect (NO in step S1), the control means 21 causes the display section 43 of the user terminal 1 to display an input error, and the process flow goes back to the screen 120 (login page) (step S6).

[User's Selection of Fault Equipment and Designation of Fault Location]

When any one of “images of electronic equipment” displayed on the screen 130 (user using equipment list page) of FIG. 9 is clicked by the mouse 45, the control means 21 causes a next screen (fault location designation page) 140 to be displayed in response to the relevant operation (HTML 2). As illustrated in FIG. 9, the selected “image of electronic equipment” is enlarged and displayed on the screen 140.

Then, a location corresponding to the fault location of the “image of electronic equipment” enlarged and displayed on the screen 140 is clicked by the mouse 45. When a predetermined location is clicked by the mouse 45, the control means 21 executes a CGI program (CGI 2).

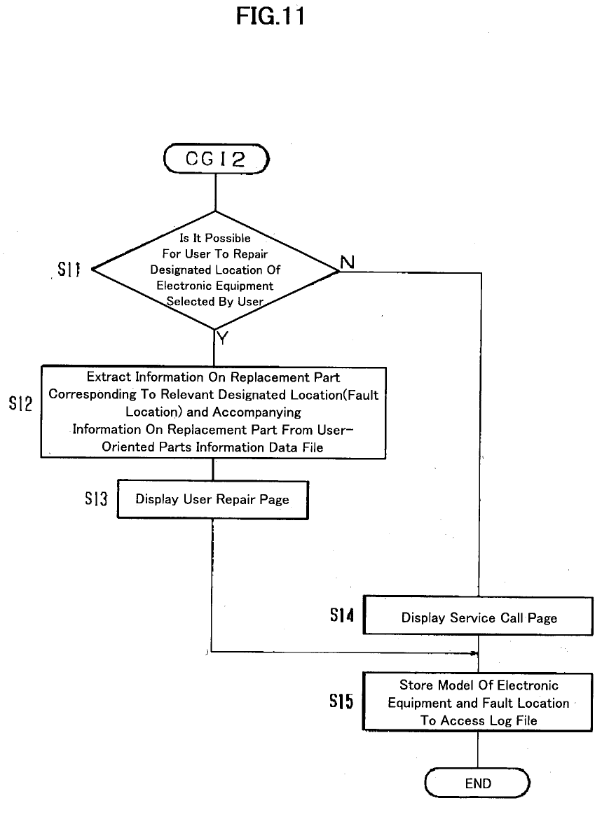

FIG. 11 is a flowchart showing a process flow using a CGI program (CGI 2). As illustrated in FIG. 11, the control means 21 first determines whether the designated location of electronic equipment selected by the user can be repaired by the user with reference to the user-oriented parts information data file 28 and service person-oriented parts information data file 29 according to the CGI program (CGI 2) (step S11).

More specifically, whether the designated location of electronic equipment selected by the user can be repaired by the user or not is determined by depending on which of the user-oriented parts information data file 28 and the service person-oriented parts information data file 29 the fault location of the electronic equipment designated by the user is included in.

When the designated location of the electronic equipment selected by the user is included in the user-oriented parts information data file 28, the control means 21 determines that the designated location can be repaired by the user (YES in step S11) and extracts information on a part necessary for replacement corresponding to the relevant designated location (the fault location) and accompanying information of the replacement part from the user-oriented parts information data file 28 (step S12).

When information on the part necessary for replacement corresponding to the relevant designated location (the fault location) and accompanying information of the replacement part are thus extracted, the control means 21 causes the display section 43 of the user terminal 1 to display a user repair page (step S13). A screen 150 of FIG. 9 is a user repair page. As illustrated in FIG. 9, information on the part necessary for replacement corresponding to the relevant designated location (the fault location) and accompanying information of the replacement part extracted in step S12 are displayed, and an order menu is displayed together with a radio button. The order menu includes, for example, (1) early delivery date but additional price, (2) normal delivery date and normal price, (3) late delivery data but reduced price, and is selected alternatively by the radio button.

On the other hand, when the designated location of the electronic equipment selected by the user is included in the service person-oriented parts information data file 29, the control means 21 determines that repair must be provided by the service person (NO in step S11) and causes the display section 43 to display a service call page (step S14).

A screen 160 of FIG. 9 is a service call page. As illustrated in FIG. 9, the service call menu is displayed together with a radio button. The order menu includes, for example, (1) contact by telephone, (2) contact by FAX, (3) contact by email, and is selected alternatively by the radio button.

Moreover, the control means 21 stores the model and fault location of the electronic equipment selected by the user to the access log file 25 to be associated with the aforementioned user name (step S15). By analyzing data thus stored in the access log file 25, for example, information on replacement frequency can be obtained for each part of the electronic equipment and this can be useful for a future development.

[Part Order by User]

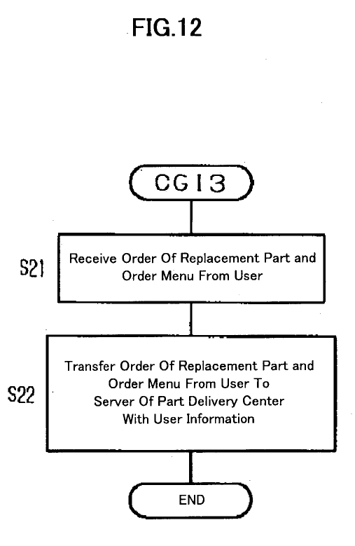

When the user selects the order menu on the screen 150 (user repair page) of FIG. 9 and clicks an “order” button, the control means 21 executes a CGI program (CGI 3). FIG. 12 is a flowchart showing a process flow using a CGI program (CGI 3). As illustrated in FIG. 12, after receiving the order of the replacement part and the order menu relating to the relevant order from the user (step S21), the control means 21 transfers the order of the replacement part and the order menu relating to the relevant order to the delivery management server 5 together with user information (user name, address, telephone number) (step S22).

The delivery management server 5 receives predetermined order information (order menu and user information) sent from the parts management server 3, which has received the order of part from the user, and generates delivery information for delivering the ordered part to a predetermined delivery location based on the relevant order information. Then, the ordered part and a procedures manual are delivered to the user having the broken-down electronic equipment by a home delivery service and the like.

In addition, since various procedures relating to the ordered part at the delivery management server 5 can be processed by the known order processing technique, the explanation here is omitted.

Then, the user, who has received the replacement part with the procedure manual, replaces the part by himself/herself, thereby the fault of electronic equipment can be repaired.

[Service Call]

When the user selects a service call menu on a screen 160 (service call page) of FIG. 9 and clicks a “selection button” by the mouse 45, the control means 21 executes a CGI program (CGI 4).

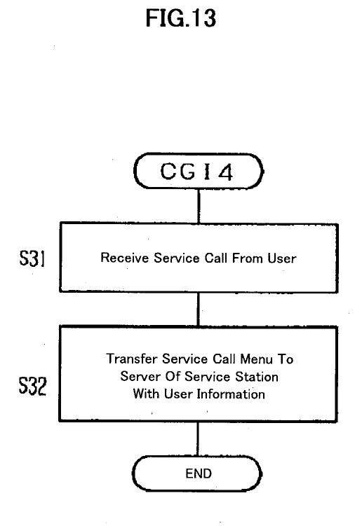

FIG. 13 is a flowchart showing a process flow using a CGI program (CGI 4). As illustrated in FIG. 13, after receiving the service call menu from the user according to the CGI program (CGI 4) (step S31), the control means 21 transfers the service call menu and user information (user name, address, telephone number) to repair management server 6 (step S32). This makes it possible to make a service call immediately when the user cannot repair electronic equipment by himself/herself.

The repair management server 6 receives predetermined fault notice information (service call menu and user information) transferred from the parts management server 3, which has received service call information on the fault location from the user, and generates service management information for deciding a service person, who is in charge of repair work, and time and date for visit based on the relevant fault notice information.

Then, the service center decides a service person to be in charged of repair work based on service management information, and causes the service person to contact the user having the broken-down electronic equipment according to the service call menu, thereafter causing the service person to visit the relevant user.

[Login by Service Person]

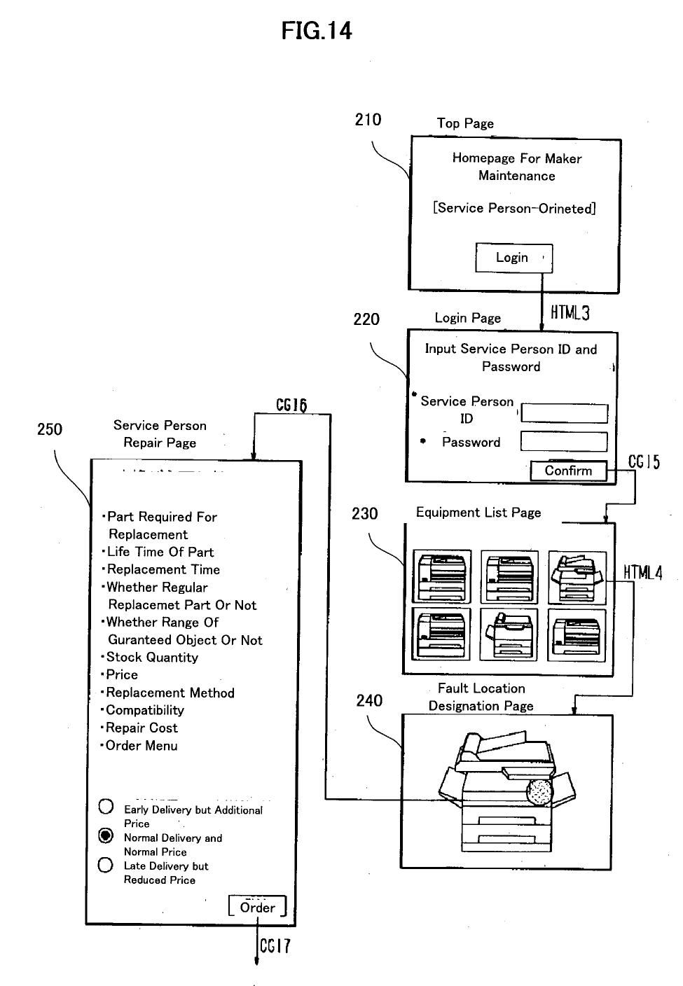

An explanation is next given of a flowchart of FIG. 14 showing a screen image displayed on the display section 43 of the portable terminal 7 when the service person, who has visited the user having the broken-down electronic equipment, browses the WEB page of the parts management server 3 from the portable terminal via the Internet 2. Additionally, in FIG. 14, “HTML+‘number’” indicates that the control means 21 of the parts management server 3 executes processing to display an HTML file prepared beforehand in the storage device 24 based on the WEB server program of the storage device 23. Moreover, “CGI+‘number’” indicates that the control means 21 executes the CGI program of the storage device 24. The control means 21 changes browsing information in accordance with the request from a viewer and executes processing of various files.

The service person must gain access to a predetermined URL provided by the parts management server 3 and login to the WEB site of the parts management center after checking the broken-down electronic equipment at the destination. Then, when the service person clicks a “login button” on a screen 210 (top page of the WEB site) displayed on the display section 43 of the portable terminal 7 by the mouse 45, the control means 21 of the parts management server 3 causes a next screen 220 to be displayed in response to the relevant operation (HTML 3).

The screen 220 shown in FIG. 14 is a login page. Since a form for inputting a service person ID and a password is displayed on the screen 220, the service person inputs each item by the keyboard 44. Then, when the service person clicks a “confirmation button” of the login page by the mouse 45 after inputting the necessary items, the control means 21 starts to execute a CGI program (CGI 5) in response to this operation.

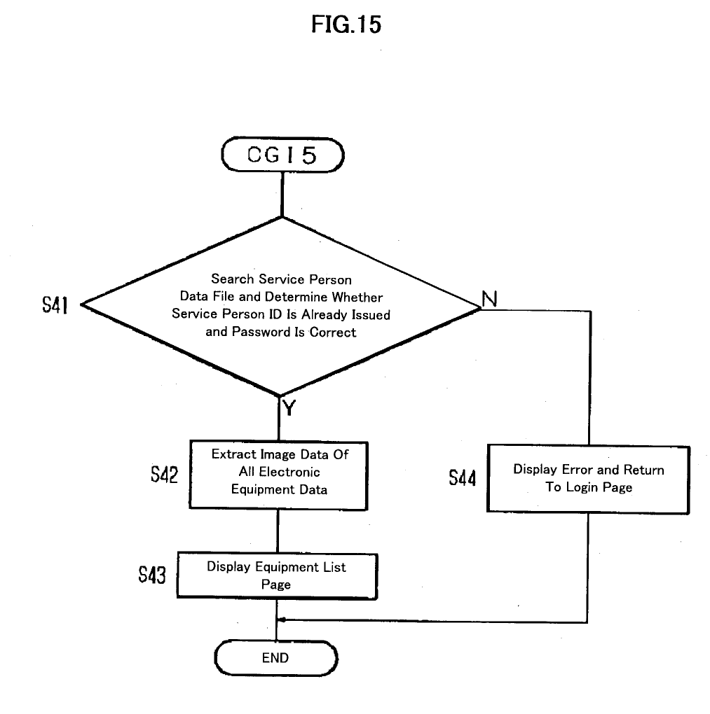

FIG. 15 is a flowchart showing a process flow using a CGI program (CGI 5). As shown in FIG. 15, the control means 21 determines whether the service person ID and password are correct with reference to the service person data file 30 according to the CGI program (CGI 5) (step S41). More specifically, the control means 21 determines whether the service person ID and password are correct by making comparison between the service person ID and password stored in the service person data file 30 and the input service person ID and password.

When determining that the input user ID and password are correct (YES in step S41), the control means 21 extracts image data of all electronic equipment from the electronic equipment image file 26 (step S42) and causes the display section 43 to display an equipment list page (step S43).

A screen 230 of FIG. 14 is an equipment list page. As illustrated in FIG. 14, on the screen 230, image data of all electric equipment extracted in step S42 is displayed by a thumb nail.

In addition, when determining that at least one of the user ID and password is incorrect (NO in step S41), the control means 21 causes the display section 43 of the portable terminal 7 to display an error, and the process flow goes back to the screen 210 (login page) (step S44).

[Service Person's Selection of Fault Equipment and Designation of Fault Location]

When any one of “images of electronic equipment” displayed on the screen 230 (equipment list page) of FIG. 14 is clicked by the mouse 45, the control means 21 causes a next screen (fault location designation page) 240 to be displayed (HTML 4). As illustrated in FIG. 14, the selected “image of electronic equipment” is enlarged and displayed on the screen 240.

Then, a location corresponding to the fault location of the “image of electronic equipment” enlarged and displayed on the screen 240 is clicked by the mouse 45. When a predetermined location is clicked by the mouse 45, the control means 21 executes a CGI program (CGI 6).

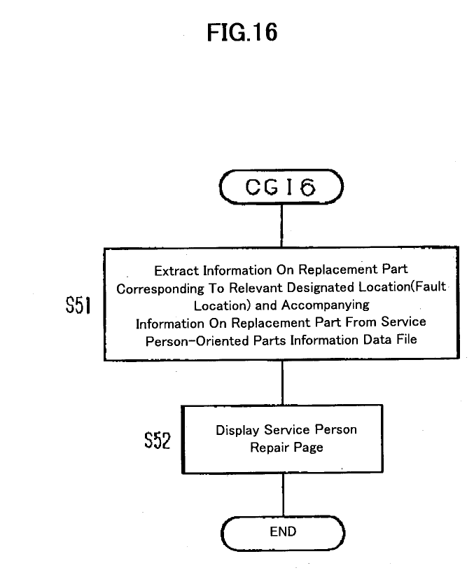

FIG. 16 is a flowchart showing a process flow using a CGI program (CGI 6). As illustrated in FIG. 16, the control means 21 extracts information on the part necessary for replacement corresponding to the designated location (the fault location) of electric equipment selected by the service person and accompanying information of the replacement part from the service person-oriented parts information data file 29 (step S51). Moreover, the control means 21 causes the display section 43 to display a service person repair page (step S52).

A screen 250 of FIG. 14 is a service person repair page. As illustrated in FIG. 14, information on the part necessary for replacement corresponding to the designated location (the fault location) and accompanying information of the replacement part extracted in step S51 are displayed and an order menu is displayed together with a radio button. The order menu includes, for example, (1) early delivery date but additional price, (2) normal delivery date and normal price, (3) late delivery data but reduced price, and is selected alternatively by the radio button.

[Part Order by Service Person]

The service person reports the content of the screen 250 to the user having the broken-down electronic equipment to select a desired order menu. Then, the service person selects the order menu on the screen 250 (service person repair page) of FIG. 14 and clicks an “order” button by the mouse 45, the control means 21 executes a CGI program (CGI 7).

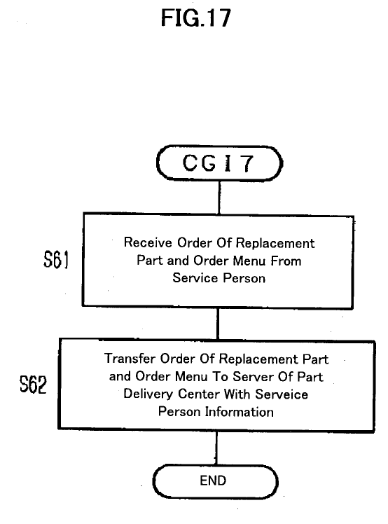

FIG. 17 is a flowchart showing a process flow using a CGI program (CGI 7). As illustrated in FIG. 17, after receiving the order of the replacement part and the order menu relating to the relevant order from the service person according to the CGI program (CGI 7) (step S61), the control means 21 transfers the order of the replacement part and the order menu relating to the relevant order to the delivery management server 5 together with service person information (service person name, telephone number, service center to which the relevant service person belongs) (step S62).

The delivery management server 5 receives predetermined order information (order menu and service center information) sent from the parts management server 3, which has received the order of part from the service person, and generates delivery information for delivering the ordered part to a predetermined service center based on the relevant order information. Then, the ordered part and a procedures manual are delivered to the service center to which the relevant service person belongs by a home delivery service and the like. In addition, since various procedures relating to the ordered part at the delivery management server 5 can be processed by the known order processing technique, the explanation here is omitted.

Then, the service person, who has received the replacement part and the procedures manual at the service center, visits the user having the broken-down electronic equipment again and replaces the part to repair the fault of the electronic equipment.

As explained above, when the user gains access to the parts management server 3 from the user terminal 1 via the Internet 2, the parts management server 3 specifies the user, who has accessed, and electronic equipment to be used by the relevant user and transmits image information for designating the fault location to the user terminal 1 to display. The parts management server 3 receives the fault location of the electronic equipment designated by the user and determines whether the fault location of electronic equipment can be repaired by the user. Then, when determining that the fault location can be repaired by the user, the parts management server 3 causes the display section 43 of the user terminal 1 to display parts information corresponding to the fault location of the relevant electronic equipment. The parts management server 3 further causes the user to order the replacement part relating to the fault location of the electronic equipment from the relevant terminal 1, and receives the order of the replacement part. This makes it possible for the user to easily determine whether he/she can repair the fault location by himself/herself when the electronic equipment breaks down. Accordingly, the user can order only the replacement part immediately if he/she can repair the electronic equipment by himself/herself and there is no need to pay unnecessary repair cost and make a service call.

Furthermore, when the service person, who has visited the user having the broken-down electronic equipment, gains access to the parts management server 3 via the portable terminal 7, the parts management server 3 specifies the relevant service person and receives the fault location of electronic equipment designated by the service person. The parts management server 3 causes the display section 43 of the portable terminal 7 to display the fault location of the relevant electronic equipment. The part management server 3 further causes the terminal 7 to order the replacement part relating to the fault location of electronic equipment and receives the order of the replacement part. This makes it possible for the service person to order the replacement part from the destination immediately.

The present invention is not limited to the aforementioned embodiment, and the various applications and modifications can be arbitrarily possible.

For example, the aforementioned embodiment explained that the WEB server program was stored in the storage device 23 such as HDD, and that the HTML file and CGI program were stored in the storage device 24 such as HDD. However, the storage device medium is not limited to HDD, and may be arbitrarily used. For example, it is possible to use various types of media, as storage media, including a flexible disk, a magnetic storage medium such as a magnetic tape, a magnet-optical medium such as MO, an optical storage medium such as CD, CD-ROM, CD-R, CD-RW, DVD-ROM, DVD-R, DVD-R, DVD-RAM, DVD-RW and the like, a semiconductor memory and so on. These storage media are used as a dedicated drive device (recording and reproducing device) to make it possible to record and reproduce a predetermined program.

Moreover, the aforementioned programs are transferred by a computer operable carrier wave, and are provided to the parts management server 3 so that these programs may be executed.

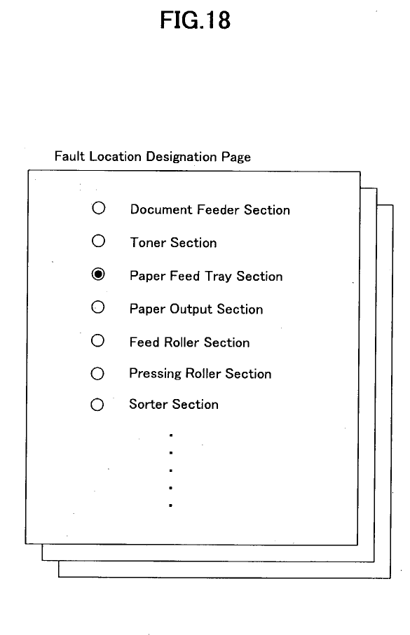

The aforementioned embodiment explained that image information of the predetermined electronic equipment, as fault location specific information for specifying the fault location of electronic equipment, was displayed to the terminal. However, the fault location specific information is not limited to image information. For example, as illustrated in FIG. 18, on a fault location designation page of a WEB screen 140 or a screen 240, a list-showing names of the respective sections of the electronic equipment may be displayed to select the corresponding fault location among from the list.

The aforementioned embodiment explained that the parts ordering apparatus included the parts management server 3, delivery management server 5 and repair management server 6. However, the apparatus configuration of the parts ordering apparatus may be arbitrarily made. For example, the parts ordering apparatus may be configured by one server computer.

The aforementioned embodiment explained that the delivery management server 5 and repair management server 6 were connected to the parts management server 3 via the LAN 4. However, the network that connects to the parts management server 3 is not limited to LAN. For example, it is possible to use a dedicated network such as a public network and a VAN (Value Added Network) or an arbitrary network in which a WAN (Wide Area Network) or radio communication is appropriately combined.

The aforementioned embodiment explained that the aforementioned various kinds of files were respectively stored in the storage devices 25 to 30. However, the configuration of the storage device of each kind may be arbitrarily made. For example, all of the above files may be stored in one storage device.

As explained above, according to the present invention, it is possible to provide a parts ordering system that can reduce time and labor required for repairing electronic equipment, a parts ordering apparatus, a part ordering method, and a storage medium.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2002-110737 filed on Apr. 12, 2002 and including specification, claims, drawings and summary. The disclosure of the above Japanese Patent Application is incorporated herein by reference in its entirety.

What is claimed is:

1. A parts ordering system comprising:
terminals; and
parts ordering apparatuses that are connected to said terminals via a predetermined network to receive a parts order from said terminal, said parts ordering apparatuses:
storing user information, repair person information, fault location specifying information for specifying a fault location of predetermined electronic equipment, and parts information on a part corresponding to the fault location of the electronic equipment;
specifying electronic equipment that is used by a user, who has accessed from said terminal, based on the user information;
sending the fault location specifying information on the specified electronic equipment to display, and receiving designation of the fault location from said terminal based on the fault location specifying information;
determining whether user repair of the designated fault location of the electronic equipment is possible;
causing the terminal to display the parts information of a replacement part for repairing the fault location of the electronic equipment when it is determined that user repair of electronic equipment is possible and receiving an order of the replacement part from said terminal based on the parts information; and
reporting to a service center, which receives repair of electronic equipment, that the relevant electronic equipment breaks down when it is determined that user repair of the electronic equipment is impossible.

2. The parts ordering system according to claim 1, said parts ordering apparatuses further:
specifying a repair person, who has accessed from said terminal, based on the repair person information;
sending the fault location specifying information for specifying a fault location of predetermined electronic equipment to said terminal that is used by the repair person to display, and receiving designation of the fault location from said terminal based on the fault location specifying information; and
causing said terminal to display repair information corresponding to the fault location of the electronic equipment, and receiving an order of a replacement part corresponding to the fault location from said terminal based on the repair information.

3. The parts ordering system according to claim 1, wherein the fault location specifying information is image information of electronic equipment, and said parts ordering apparatuses cause said terminal to display the fault location based on a display screen on which the image information is displayed by said terminal.

4. A parts ordering apparatus that is connected to terminals via a predetermined communication network to receive a parts order from said terminals, said parts ordering apparatus comprising:
user specifying means for specifying a user, who has accessed from said terminal, and electronic equipment that is used by the relevant user;
first fault location designating means for sending fault location specifying information for specifying a fault location of the electronic equipment to said terminal to display and for designating the fault location of the electronic equipment from said terminal based on the fault location specifying information;
first fault location receiving means for receiving the fault location of the electronic equipment designated by said first fault location designating means from said terminal;
user repair possibility determining means for determining whether user repair of the received fault location of the electronic equipment is possible;
first replacement part displaying and ordering means for causing said terminal to display information corresponding to the relevant fault location of the electronic equipment and to order a replacement part corresponding to the fault location of the electronic equipment from said terminal based on the information when user repair possibility determining means determines that user repair of the received fault location of the electronic equipment is possible; and
first replacement part ordering means for receiving an order of the replacement part by said first replacement part displaying and ordering means.

5. The parts ordering apparatus according to claim 4, further comprising fault reporting means for reporting to a service center, which receives repair of predetermined electronic equipment, that the relevant electronic equipment breaks down when user repair possibility determining means determines that user repair of the received fault location of the electronic equipment is impossible.

6. The parts ordering apparatus according to claim 4, further comprising:
repair person specifying means for specifying a repair person, who has accessed from said terminal, and electronic equipment to be repaired by the relevant repair person;
second fault location designating means for sending fault location specifying information for specifying a fault location of the electronic equipment to said terminal to display and for designating the fault location of the electronic equipment from said terminal based on the fault location specifying information;
second fault location receiving means for receiving the fault location of the electronic equipment designated by said second fault location designating means from said terminal;
second replacement part displaying and ordering means for causing said terminal to display information corresponding to the fault location of the electronic equipment received by said second fault location receiving means and to order a replacement part corresponding to the fault location of the electronic equipment from said terminal based on the information; and
second replacement part ordering means for receiving an order of the replacement part by said second replacement part displaying and ordering means.

7. The parts ordering apparatus according to claim 4, wherein replacement parts information on the replacement part corresponding to the fault location is included in information corresponding to the fault location of the electronic equipment displayed on said terminal by said first replacement part displaying and ordering means.

8. The parts ordering apparatus according to claim 6, wherein replacement parts information on the replacement part corresponding to the fault location is included in information corresponding to the fault location of the electronic equipment displayed on said terminal by said second replacement part displaying and ordering means.

9. The parts ordering apparatus according to claim 4, further comprising repair part storing means for storing information relating to the user, information relating to the electronic equipment and information relating to the fault location of the electronic equipment to be associated with one another when the fault location of the electronic equipment is received by said first fault location receiving means.

10. A computer-readable storage medium having a program recorded thereon, said program causing a computer to execute all or a part of the functions of the respective means of the parts ordering apparatus described in any one of claims 4 to 9.

11. A computer-operable carrier wave transferring a program, said program causing a computer to execute all or a part of the functions of the respective means of the parts ordering apparatus described in any one of claims 4 to 9.

12. A parts ordering method in which connection to terminals is made via a predetermined network to receive a parts order from said terminal, said method comprising the steps of:
storing user information, repair person information, fault location specifying information for specifying a fault location of predetermined electronic equipment, and parts information on a part corresponding to the fault location of the electronic equipment;
specifying a user, who has accessed from said terminal and electronic equipment that is used by the relevant user, based on the user information;
sending the fault location specifying information on the specified electronic equipment to display;
receiving designation of the fault location from said terminal based on the fault location specifying information to determine whether user repair of the designated fault location of the electronic equipment is possible;
causing the terminal to display the parts information corresponding to the fault location of the electronic equipment when it is determined that user repair of electronic equipment is possible; and
receiving an order of the replacement part corresponding to the fault location from said terminal based on the parts information.

13. The parts ordering method according to claim 12, further comprising the step of reporting to a service center, which receives repair of the electronic equipment, that the relevant electronic equipment breaks down when it is determined that user repair of the electronic equipment is impossible in said determining step.

14. The parts ordering method according to claim 12, further comprising the steps of:
specifying a repair person, who has accessed from said terminal, based on the repair person information;
sending the fault location specifying information for specifying a fault location of predetermined electronic equipment to said terminal that is used by the repair person to display;
receiving designation of the fault location from said terminal based on the fault location specifying information to cause said terminal to display repair information corresponding to the fault location of the electronic equipment; and
receiving an order of a replacement part corresponding to the fault location from said terminal based on the repair information.

15. The parts ordering method according to claim 13, further comprising the steps of:
specifying a repair person, who has accessed from said terminal, based on the repair person information;
sending the fault location specifying information for specifying a fault location of predetermined electronic equipment to said terminal that is used by the repair person to display;
receiving designation of the fault location from said terminal based on the fault location specifying information to cause said terminal to display repair information corresponding to the fault location of the electronic equipment; and
receiving an order of a replacement part corresponding to the fault location from said terminal based on the repair information.

16. The parts ordering method according to claim 12, further comprising the step of storing information relating to the user, information relating to the electronic equipment and information relating to the fault location of the electronic equipment to be associated with one another when the fault location of the electronic equipment is received based on the fault location specifying information in said determining step.
